(19) United States
(12) Patent Application Publication
(10) Pub. No.: US 2025/0103947 A1
(43) Pub. Date: Mar. 27, 2025

(54) DATA-DRIVEN METHOD FOR DISCOVERING CONSERVATION PRINCIPLES IN PHYSICAL SYSTEMS

(71) Applicants: Rolos AG, Schaffhausen (CH); Constructor Education and Research Genossenschaft, Schaffhausen (CH)

(72) Inventors: Andrey Ustyuzhanin, Singapore (SG); Antonii Belyshev, Bremen (DE); Alexander Kovrigin, Bremen (DE); Serg Bell, Costa del Sol (SG); Stanislav Protasov, Singapore (SG); Nikolay Dobrovolskiy, Sofia (BG)

(21) Appl. No.: 18/474,665

(22) Filed: Sep. 26, 2023

(51) Int. Cl. G06N 20/00

(52) U.S. Cl. CPC G06N 20/00

(57) ABSTRACT

Systems and methods for uncovering a conservation law in physical systems including evaluating collected data by a representation learning system. Analyzing the collected data by a topological learning analysis system, transferring the data into at least two displayable trajectories. Generating a distance matrix by computing so-called Wasserstein distances between the trajectories, with the distance matrix showing a shape space between the trajectories. Embedding the shape space of the distance matrix into lower dimensions by using a so-called uniform manifold approximation and projection (UMAP). Determining at least two scores for different embeddings to choose a score, representing the shape space, and/or representing a minimal dimensionality. Using a symbolic regression to identify a closed form of the integrals of motion.

### TECHNICAL FIELD

Methods and systems consistent with the present disclosure generally relate to machine learning and artificial intelligence. More particularly, embodiments relate to uncovering conservation laws evaluating collected data by a representation learning system and analyzing the data by a topological learning analysis system.

### BACKGROUND

US 2018/0260703 A1 discloses a system for training a neural network model comprising a plurality of layers including a first hidden layer. The first hidden layer is associated with a first set of weights. The system comprises at least one computer hardware processor. The computer hardware processor is programmed to perform the following: Obtaining training data; selecting a unitary rotational representation for representing a matrix of the first set of weights. The system further comprises updating values of the plurality of parameters in a selected unitary rotational representation. The rotational representation is designed for representing a matrix of a set of weights for the at least one hidden layer. Also, it is designed for saving a trained neural network model.

A traditional theoretical physics method is based on expert knowledge and pre-defined equations. Also, a differential calculus is applied to uncover conservation laws. So-called traditional theoretical physics methods however, often require extensive manual effort, and also require a robust insight into complex physical phenomena.

So-called Expert-Driven Machine Learning is another system known in the art. The system manually selects hyper-parameters and other features based on expert knowledge from physicists. Even though the system yields valid results, it is also fairly time-consuming. Such systems are less accessible to a user lacking expert knowledge.

Another system known in the art is referred to as a semi-supervised or supervised learning algorithm. Semi-supervised or supervised learning algorithms may use labelled examples of known conservation laws. The known conservation laws are used to train a model. However, semi-supervised or supervised learning algorithms are limited by the lack of known conservation laws for training and validation.

Methods for uncovering conservation laws in physical systems commonly rely on manual inspection. They may also rely on expert-selected hyper-parameters.

Therefore, there is a need for a robust, accessible technique that leverages a data-driven approach to discover conservation principles in physical systems.

### SUMMARY

Embodiments described or otherwise contemplated herein substantially meet the aforementioned needs of the industry. Embodiments described herein include systems and methods for uncovering a conservation law in physical systems. As used herein, a hyper-parameter is a parameter of a prior distribution. Embodiments distinguish the hyper-parameter from a parameter that is focused on a system to be analyzed.

In an embodiment, a method for uncovering a conservation law in physical systems comprises evaluating collected data by a representation learning system, analyzing the collected data by a topological learning analysis system, and transferring the data into at least two displayable trajectories; generating a distance matrix by computing Wasserstein distances between the trajectories, with the distance matrix showing a shape space between the trajectories; embedding the shape space of the distance matrix into lower dimensions by using a uniform manifold approximation and projection (UMAP); determining at least two scores for different embeddings to choose a score; representing at least one of the shape space, or a minimal dimensionality; and using a symbolic regression to identify a closed form of integrals of motion.

In an embodiment, a system for uncovering a conservation law in physical systems comprises a representation learning system configured to evaluate collected data, a topological learning analysis system configured to analyze the collected data and transfer the data into at least two displayable trajectories, a distance matrix generated by computing Wasserstein distances between the trajectories, wherein the distance matrix shows a shape space between the trajectories, and wherein the shape space of the distance matrix is embedded into lower dimensions by using a so-called uniform manifold approximation and projection (UMAP), wherein at least two scores for different embeddings are determined to choose a score, and a representation module configured to represent at least one of the shape space, or a minimal dimensionality, wherein a symbolic regression is used to identify a closed form of integrals of motion.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Subject matter hereof can be more completely understood in consideration of the following detailed description of various embodiments in connection with the accompanying figures, in which:

FIG. 1 is an illustrative calculation of the Wasserstein distance, the data is determined using an algorithm, according to an embodiment.

FIG. 2 is a graph of the Wasserstein distance of the collected data, according to an embodiment.

FIG. 3 is a graph of embedding of data linked with a computed score, according to an embodiment.

FIG. 4 is a graph of determining a number of conserved quantities, including a corresponding threshold and point of stopping, according to an embodiment.

FIG. 5 is an illustrative calculation of the Wasserstein distance, the data is determined using an algorithm, according to an embodiment.

FIG. 6 is a graph of the Wasserstein distance of the collected data, according to an embodiment.

FIG. 7 is a graph of embedding of data linked with a computed score, according to an embodiment.

FIG. 8 is a graph of determining a number of conserved quantities, including a corresponding threshold and point of stopping, according to an embodiment.

FIG. 9 is a block diagram of a coupled oscillator, according to an embodiment.

FIGS. 10 to 15 are graphs illustrating the effect of a coupled oscillator on Wasserstein distances, according to embodiments; FIG. 11 illustrates the effects of two different moments on Wasserstein distances, FIGS. 12 and 13 illustrate the dimensions of the embeddings; and FIGS. 14 and 15 illustrate colored gradations for embedded component.

FIGS. 16 to 21 are graphs illustrating a coupled oscillator, according to embodiments.

FIGS. 22 to 25 are graphs illustrating the effect of a noisy pendulum, according to embodiments.

FIGS. 26 to 29 are graphs illustrating the effect of a noisy pendulum, according to embodiments.

FIG. 30 is an illustrative calculation of the Wasserstein distance, the data is determined using an algorithm, according to an embodiment.

FIG. 31 is a graph of embedding of data linked with a computed score, according to an embodiment.

FIG. 32 is a graph of determining a number of conserved quantities, including a corresponding threshold and point of stopping, according to an embodiment.

FIG. 33 is a graph illustrating a constant embedding colored by energy, according to an embodiment.

FIG. 34 is a graph illustrating the correlation of the embedding values with the energy values, according to an embodiment.

FIG. 35 is an illustrative calculation of the Wasserstein distance, the data is determined using an algorithm, according to an embodiment.

FIG. 36 is a graph of embedding of data linked with a computed score, according to an embodiment.

FIG. 37 is a graph of determining a number of conserved quantities, including a corresponding threshold and point of stopping, according to an embodiment.

FIG. 38 is a graph illustrating a constant embedding colored by energy, according to an embodiment.

FIG. 39 is a graph illustrating the correlation of the embedding values with the energy values, according to an embodiment.

FIG. 40 is a graph illustrating the correlation of the number of samples with the boundary values, according to an embodiment.

FIGS. 41 to 46 are graphs illustrating predetermined correlations according to embodiments.

FIG. 47 is a flowchart of a method for uncovering a conservation law in physical systems, according to an embodiment.

FIG. 48 is a flowchart of a method for uncovering a conservation law, according to an embodiment.

FIG. 49 is a block diagram of a system for uncovering a conservation law, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

Systems and methods provide techniques that can be applied across various disciplines without the need for extensive expert domain knowledge. To inspect the resilience and the universal application of a system, the embodiments allow for the amassing of diverse and large-scale datasets. Embodiments can be applied to a variety of disciplines. Embodiments have been tested across different disciplines, which show a large variety of cross-disciplinary applications.

By way of example, embodiments can be applicable to at least one of the following: A control system, astrophysics, biology, environmental sciences, material science, etc. The broad applicability of embodiments enhances its utility and the scope of the influence of the object of embodiments.

Embodiments allow integration with other machine learning methods and/or machine learning systems. The machine learning method and/or system can be combined with other machine learning algorithms. The combination with other machine learning algorithms allows discovery precision and the efficiency of conservation laws to be increased.

Embodiments also allow rigorous benchmarking against existing analytical and numerical techniques. Thus, a predictive power and a robustness can be ensured.

According to embodiments, computational resources can be saved. Embodiments prove to be computationally inexpensive. Embodiments do not require a so-called Graphics Processing Unit (GPU) and/or cloud-based resources. Thus, manufacturing costs can be significantly reduced.

By way of example, but not exclusively, embodiments may reveal previously unknown conservation principles comprising fundamental principles in various domains. Embodiments can also boost interdisciplinary research.

The application adopts a data-driven approach. Embodiments enhance the potential of uncovering and understanding complex conservation laws.

Embodiments help to govern physical systems, thus providing a precise and more detailed perspective on at least one mechanism that drives the systems.

User-friendly software packages and/or applications can be developed on the basis of embodiments. Thus, embodiments are more accessible to scientists and/or users lacking programming skills.

Embodiments of systems and methods described herein are not dependent on expert-selected hyper-parameters, unlike traditional approaches that require significant expert knowledge for parameter selection. Thus, embodiments are universally applicable across various disciplines. A broad application arena sets it apart from discipline-specific technologies.

Known technologies usually focus on uncovering known or hypothesized conservation laws. In contrast, embodiments described herein are focused on discovering previously unknown conservation principles. Thus, embodiments add a fresh dimension to the field at question.

Advantageously, embodiments rely on theoretical methods that are based on a physical framework, respectively.

Also, embodiments advance the integration of data-driven approaches in understanding a specific physical world.

### Algorithm

In computer science, an algorithm is a finite sequence of rigorous instructions. Typically, the algorithm is used to solve a class of specific problems. It may also be used to perform a computation. Alternatively, an algorithm can be used as a specification for performing calculations and data processing.

The algorithm of embodiments includes the operations referred to below. In the order of the operations explained in more detail below, embodiments discover conserved quantities both through a so-called shape space as such and through a structure of the shape space. In an embodiment, the structure of the shape space is obtained by the Wasserstein distance, respectively. The effect of the Wasserstein distance is explained in more detail below.

### First Aspect

According to a first aspect of embodiments, a method for uncovering a conservation law in physical systems pursues a number of operations.

Embodiments fuse and/or integrate a so-called representation learning and a so-called topological analysis.

The process of integrating both representation learning and the topological analysis takes place at the same time as the process of uncovering conservation laws in physical systems.

In an embodiment, collected data are evaluated by a representation learning system. The collected data analyzed by a topological learning analysis system are transferred into at least two displayable trajectories.

A distance matrix is generated by computing so-called Wasserstein distances between the trajectories, with the distance matrix showing a shape space between the trajectories.

The shape space of the distance matrix is embedded into lower dimensions by using a so-called uniform manifold approximation and projection (UMAP).

At least two scores for different embeddings are determined to choose a score. The chosen score represents the shape space. The chosen score also represents a minimal dimensionality.

A symbolic regression is used to identify a closed form of the integrals of motion.

Embodiments fuse at least two components. A first component can be referred to as representation learning. A second component can be referred to as topological analysis.

Embodiments are directed at integrating at least two components. The process of integrating the components takes place at the same time as the process of uncovering conservation laws in physical systems. Thus the process of integrating the components represents a novel concept distinct from established techniques.

In other words, the approach of integrating the at least two components in uncovering conservation laws in physical systems represents a novel concept distinct from established techniques.

An embodiment provides a use of a data-driven approach in a physical systems arena.

### Representation Learning System

As an example, embodiments use data from a first setting to extract information (A). The same information (A) may also be useful when learning or when making a prediction in a second setting. Thus, it is the main idea of the representation learning system that the same representation can be useful both in the first and in the second setting.

By way of example, using the same representation both in the first and in the second setting gives the representation the opportunity to benefit from any additional or training data that is available in the first setting and in the second setting.

### Trajectory

In an embodiment the trajectory is represented by at least two points on it. Each point represents at least one data, respectively. In another embodiment the trajectory is ergodic. Embodiments understand by the term ergodic that during a temporal development of a system all physically possible states may actually be achieved.

The amplitudes of at least two variations in different conserved quantities have a similar effect on the Wasserstein distance.

In an additional embodiment distances from all trajectories are determined to the reference trajectory.

Embodiments provide for data to be collected. The collected data comprise of at least two trajectories from a dynamical system. By way of example, the collected data can comprise hundred trajectories from a dynamical system. Embodiments can include collected data can also comprise a number of several hundred trajectories.

In the following, embodiments assume that the arrangement of data follows at least two trajectories.

In an embodiment, the data can be represented by a set of at least two points and/or dots that are arranged on at least one trajectory.

### Wasserstein Matrix

According to embodiments, a Wasserstein distance matrix refers to a distance function that is defined between probability distributions on a given matrix space, wherein the matrix space is referred to as M.

For simplicity, embodiments assume that each distribution can be viewed as a pile of earth of a pre-defined weight arranged on a matrix space. By way of example, the Wasserstein matrix refers to the minimum cost of turning one pile of earth into another pile of earth. In other words, the Wasserstein matrix is assumed to be the amount of the pile of earth (A) (i.e. weight of the pile of earth A) to be moved times the mean distance, the pile of earth (A) has to be moved.

The Wasserstein distance may also be computed for dimensionless data. Usually however, the data is normalized. According to embodiments the data is normalized such that the data has a value along each coordinate of a coordinate system.

Also, the data may have a unit maximal absolute value.

Embodiments set up a distance matrix by computing so-called Wasserstein distances between trajectories.

In an embodiment, data is normalized for computing the Wasserstein distances, having a zero value and/or a unit maximal value.

### Shape Space

According to embodiments, shape space is an active research field in computer vision study.

In embodiments, the shape distance defined in a shape space provides a simple and refined index to represent a unique shape.

The Wasserstein distance defines an already known Riemannian metric for the Wasserstein space.

According to embodiments, similarities between shapes are intrinsically measured. Also, the shape space is robust to image noise. Thus the shape space has a potential for a 3D shape indexing and for classification research.

### Uniform Manifold Approximation and Projection for Dimension Reduction (UMAP)

Embodiments generate the distance matrix referred to above as a Wasserstein-matrix. To generate the Wasserstein-matrix, Wasserstein distances between trajectories are computed.

Having generated the distance matrix, embodiments embed at least one shape space into lower dimensions using a so-called UMAP. As described herein, UMAP is understood to be a dimension reduction technique that is used for a visualization similar to a so-called t-SNE.

The t-SNE is an algorithm, also referred to as t-Distributed Stochastic Neighbor Embedding. The t-SNE refers to a nonlinear dimension reduction. The algorithm (t-SNE) allows embodiments to separate data that cannot be separated by a straight line.

Also, UMAP stands for a general non-linear dimension reduction.

UMAP can also be defined as a uniform manifold approximation and projection for a dimension reduction.

Exemplary, but not exclusively, UMAP is an algorithm based on the following assumptions about data:
First: The data is evenly distributed over an already known, so-called Riemannian manifold. Wherein, the data is evenly distributed over an already known so-called Riemannian matrix.
Second: The Riemannian matrix is locally constant.
Third: The already known so-called Riemannian manifold is locally connected.

Embodiments use UMAP to generate a series of the lower dimensional representations of the shape space. Embodiments use UMAP because of UMAP's ability to embed into shape spaces different from R″. R″ may represent a spherical shape space that has a dimensionality equal to 2. However, UMAP may not be embedded into a space R³.

In an embodiment, the UMAP comprises an output_metric hyper-parameter. Embodiments control a topology of a target space by varying a so-called output_matrix hyper-parameter of the UMAP.

By way of example, but not exclusively, embodiments use the distance on the circle along an arc.

In an embodiment, varying an output_metric hyper-parameter of the UMAP controls a topology of a target space.

Exemplary, but not exclusively, the output metrics can be the shortest way along the sphere and/or along a torus, wherein:

def arc_dist(x, y):
d = x − y
while d > 1:
d −= 2
while d < −1:
d += 2
return abs(d).

### Symbolic Regression

Embodiments are understood by the term symbolic regression to be a type of regression analysis. The regression analysis searches the space of mathematical expressions to find the model that best fits a given dataset, both in terms of accuracy and simplicity.

According to embodiments, the symbolic regression identifies the closed form of the conserved quantities. The identification process is done by learning how to associate an individual point of a trajectory to a conserved quantity given by UMAP.

Embodiments repeat the identification process to reveal all non-trivial distinctive N_conserved integrals of motion. Embodiments lead to a number of N_converved closed-form equations of conserved quantities of a given system.

### Choosing the Embedding Dimensionality

Embodiments compute a neighbor deviation score (NDS) for all embeddings. For other embeddings, embodiments compute scores differing from each other.

Embodiments choose the one score that represents the shape space both in a sufficient manner and has the minimal possible dimensionality.

Having computed the NDS for all embeddings, embodiments determine the number of conserved quantities in the system.

The method also generates a matrix, showing the shape space between the displayable forms of the sets of data. In an embodiment, the representation of the shape space by the embedding is measured by a so-called neighbor deviation score (NDS).

In an embodiment, a reference trajectory is defined for the determination of the NDS. In an embodiment, the NDS is an average absolute deviation in rank of the at least two trajectories.

### Neighbor Deviation Score (Nds)

Embodiments measure the extent to which the embedding represents the shape space. To measure the extent, embodiments utilize a Neighbor Deviation Score (NDS).

The determination of the NDS is carried out according to the following operations.

In a first operation, embodiments randomly choose one trajectory. The chosen trajectory is referred to as a reference trajectory.

In a second operation, embodiments compute the distances from all trajectories to the reference trajectory.

In a third operation, the second operation is repeated in the embeddings.

In a fourth operation, embodiments sort all trajectories by the distance to the reference trajectory.

Depending on their distances relative to the reference trajectory, a fifth operation compute the ranks of the trajectories as such. In a sixth operations embodiments compute the ranks in the embedding.

For example, the ranks of the trajectories in the fifth operations are referred to as r1, to rn. Further, the ranks in the embedding are referred to as r′1, to r′n in the sixth operations.

According to embodiments, the NDS is the average absolute deviation in the rank, wherein: NDS=1/n \sum labs {r_i-\prime {r_i}}.

Depending on nonlinearities in the shape space, the representation of the shape space is sufficient in a pre-defined neighborhood of the reference trajectory.

Embodiments are configured to adjust the NDS. Embodiments compute the NDS for at least two trajectories and adjusts the NDS. The adjustment is done only in case of the trajectory j_1, . . . , j_{n_nearest} that is the nearest to the reference trajectory.

Embodiments are configured to normalize the NDS by the number of trajectories (n_traj). The normalization of the NDS by the number of trajectories effects that the NDS is comparable for data sets. With the individual data sets having a different number of trajectories, respectively.

The formula for calculating the NDS is:

$$NDS = \frac{1}{n\_traj} \frac{1}{n\_nearest} \text{?} \vert {r}_{i} - {r}_{i}^{′} \vert .$$

$$\text{?} \text{indicates text missing or illegible when filed}$$

Embodiments stabilize the NDS by averaging the NDS over various reference trajectories. By way of example, averaging can be done over a number of n_reference-40 various reference trajectories. Moreover, any number of reference trajectories can be applied. Also, the reference trajectories can be selected randomly.

In embodiments, other reference numbers may also be applied.

The stability of the system can be checked by adding so-called error bars in a number of graphs.

Embodiments suggest following the operations referred to above to discover conserved quantities through the shape space. Also, embodiments discover the structure of the shape space obtained by the Wasserstein distances.

### Topological Analysis

A topological analysis (TDA), also referred to as topological learning analysis, is an approach to analyze data using techniques from topology. TDA analyzes data in a way that is insensitive to a previously chosen metric. Also, TDA provides a reduction in dimensionality of the data.

The method computes at least one distance between the displayable forms of the sets of data.

Using TDA, embodiments are able to present huge amounts of data into an understandable and easy-to-present form.

The method transfers at least two sets of data, each into a displayable multi-dimensional form.

Exemplary, but not exclusive, embodiments realize the TDA with the help of trajectories. In an embodiment, the topological learning system defines a target space.

In another embodiment, the topology of the target space is controlled by using the distance on a circle along the arc.

In an embodiment the target space is controlled by varying the output_metric hyper-parameter of the UMAP.

### Second Aspect

A second aspect of embodiments refers to the term associated with the first aspect of embodiments and described in more detail above.

According to a second aspect of embodiments, a method for uncovering a conservation law analyzes data by a topological learning analysis system.

### Third Aspect

According to a third aspect of embodiments, collected data are evaluated by a representation learning system.

The data is analyzed by a topological learning analysis system. In an embodiment, the topological learning analysis system transfers the data into at least two displayable trajectories.

The distance matrix is generated by computing so-called Wasserstein distances between the trajectories. In an embodiment, the distance matrix shows a shape space between the trajectories. The shape space of the distance matrix is embedded into lower dimensions by using a so-called uniform manifold approximation and projection (UMAP).

At least two scores for different embeddings are determined to choose a score. In an embodiment, the score can represent the shape space. The score can also represent a minimal dimensionality.

A symbolic regression is used by embodiments to identify a closed form of the integrals of motion.

The third aspect of embodiments refers to the term associated with the first aspect of embodiments and described in more detail above.

### Example

Embodiments specify that the NDS decreases with an increasing dimensionality of embedding.

Embodiments also specify that the dimensionality of embedding is less than the number of conserved quantities.

Embodiments further specify that the NDS stops decreasing once the dimensionality of embedding reaches the number of conserved quantities.

Embodiments define a so-called stopping point. The stopping point is the point where the NDS sequence stops decreasing. The stopping point is found by using so-called early stopping.

The term early stopping implies that embodiments compute the differences between each individual score of the NDS and the next one. Once the difference is lower than a pre-defined threshold, the stopping point is found.

To determine the threshold, embodiments simulate sequences of the NDS for a few synthetic systems. Then, embodiments choose the threshold such that the algorithm finds the right number of conserved quantities in these systems.

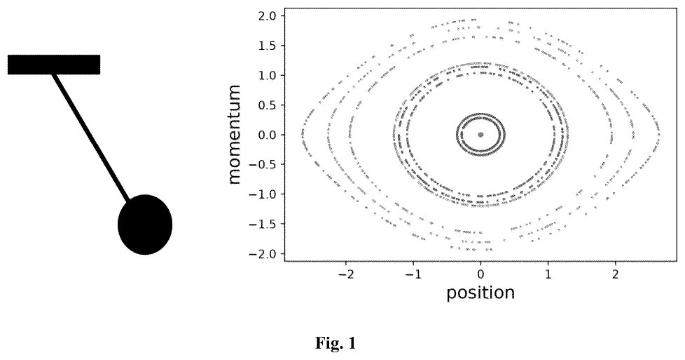

To calculate the Wasserstein distance, the data is determined using an algorithm. The algorithm shown in FIG. 1 is a predetermined momentum. In particular, in FIG. 1, the momentum is plotted on the Y-axis.

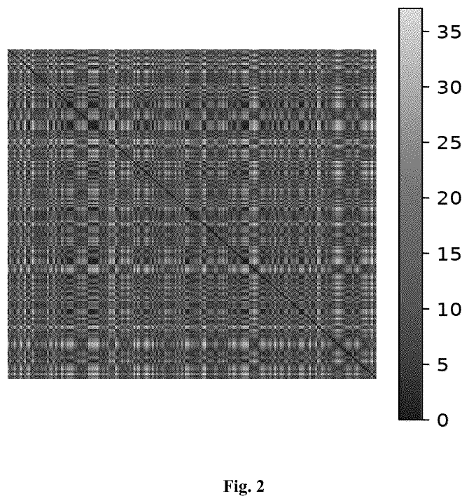

FIG. 2 represents the Wasserstein distance of the collected data. The density of the shape space of the data is shown in color in FIG. 2. As the distance between the data grows, the lighter the color on the Y-axis of the color scale.

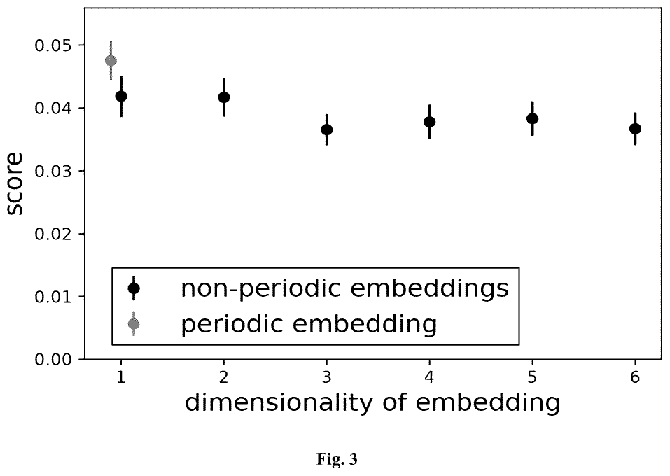

FIG. 3 illustrates the embedding of the data linked with a computed score. For example, in FIG. 3, the Y-axis shows the score. The values for the dimension of the embedding are plotted on the X-axis.

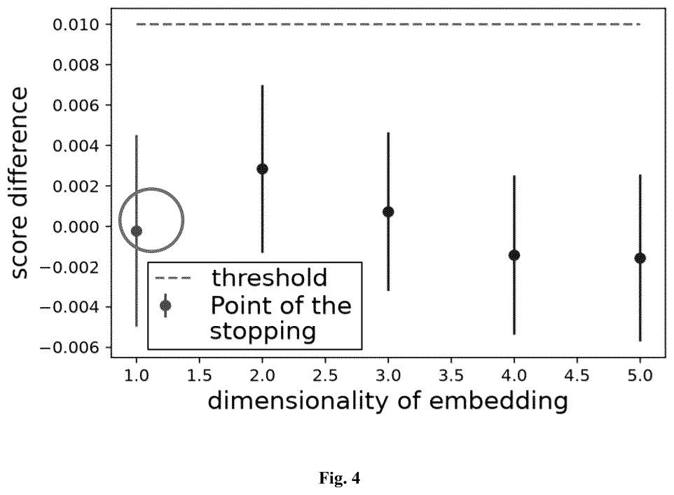

The coordinate system of FIG. 4 shows the score difference on the Y-axis. In contrast, the X-axis represents the dimensionality of the embedding. Accordingly, FIG. 4 shows the corresponding threshold and the point of stopping.

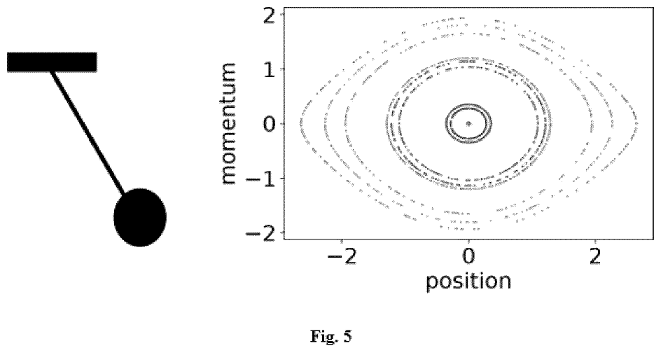

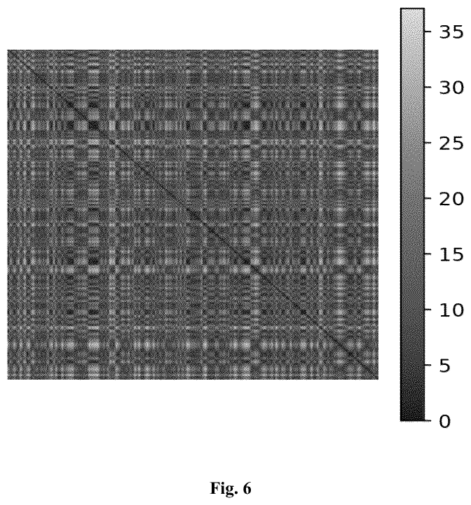

FIGS. 5 to 8 correspond to FIGS. 1 to 4, with the difference that larger distances on the Y-axis of the momentum lead to a different threshold value and a different stopping point.

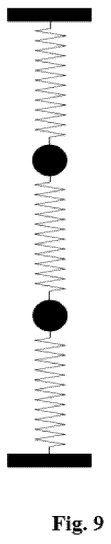

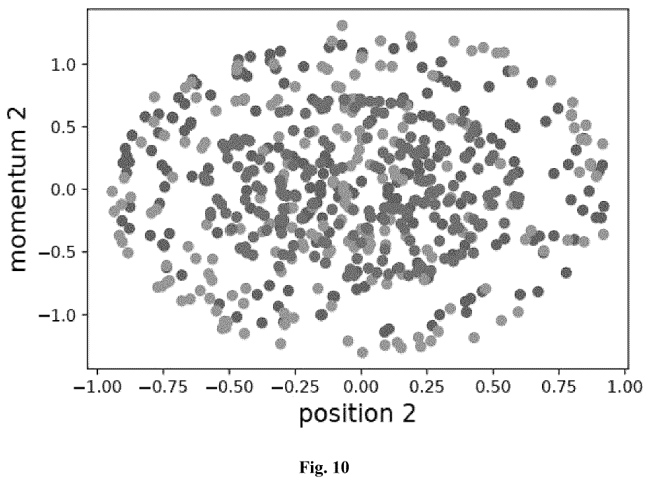

FIG. 9 depicts a coupled oscillator. FIGS. 10 to 15 show the effect of a coupled oscillator (e.g. such as that of FIG. 9) on the Wasserstein distances.

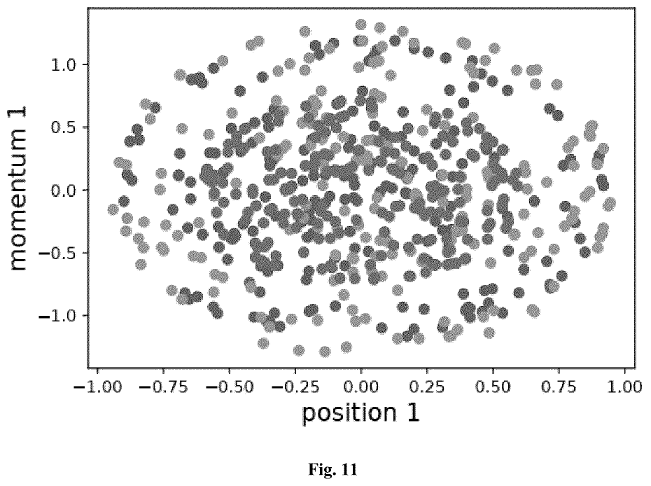

FIG. 10 and FIG. 11 represent the effects of two different moments on Wasserstein distances.

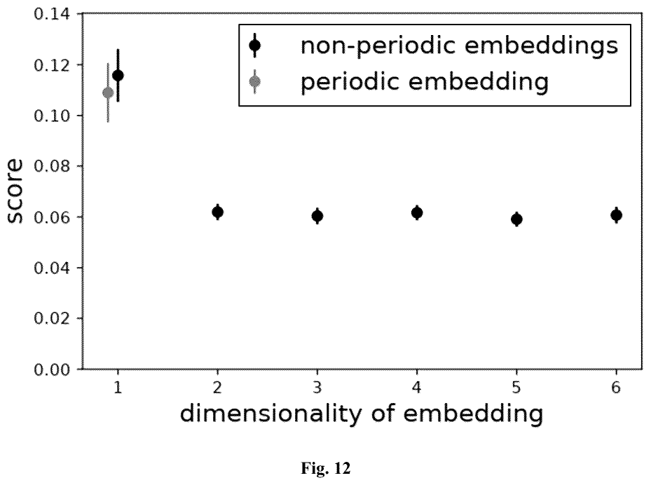

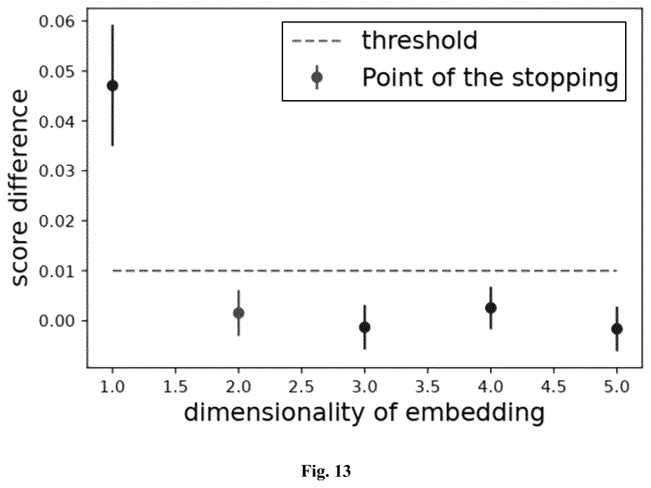

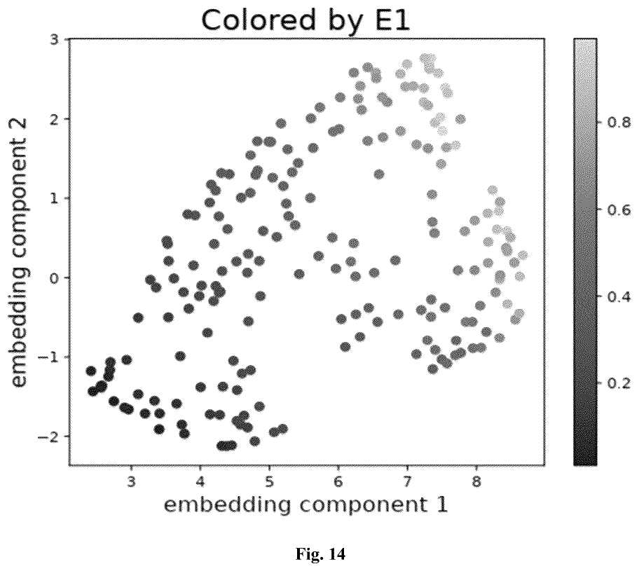

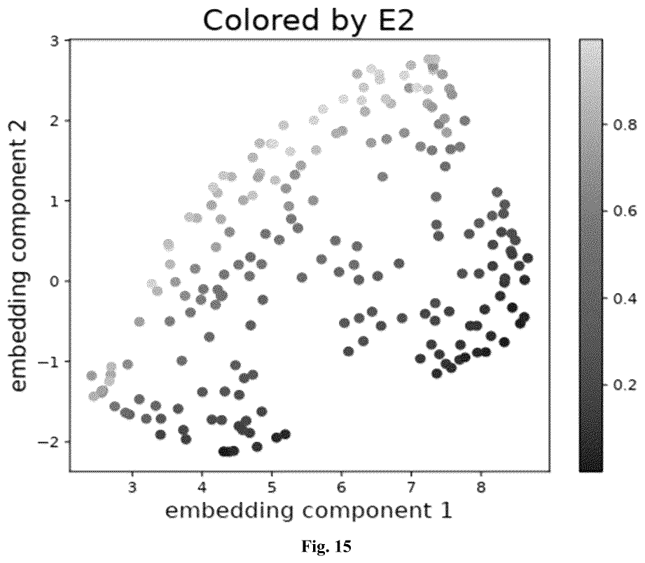

In FIGS. 12 and 13, the dimensions of the embeddings are shown on the X-axes, depending on the respective scores (FIG. 12). The X-axis of FIG. 13 shows the respective score differences. FIGS. 14 and 15 illustrate colored gradations for embedded components 1 and 2.

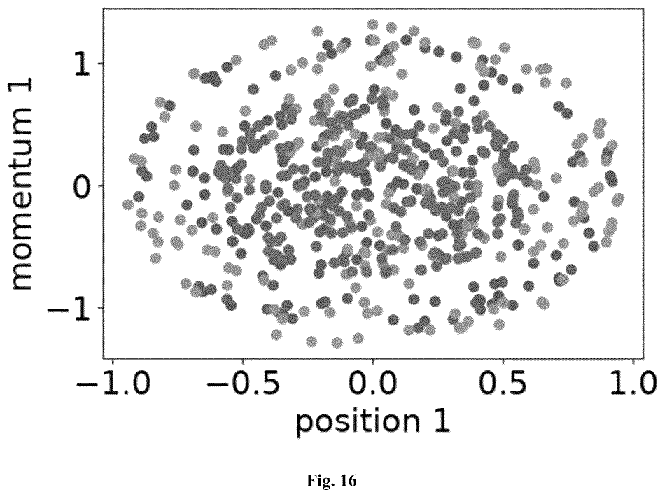

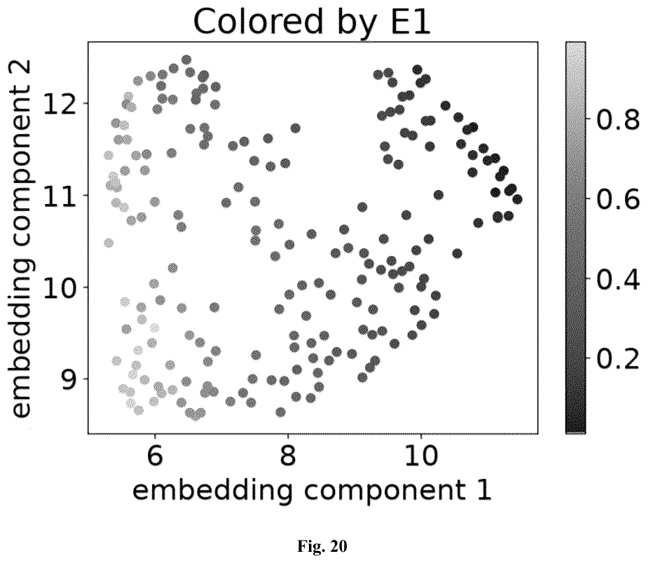

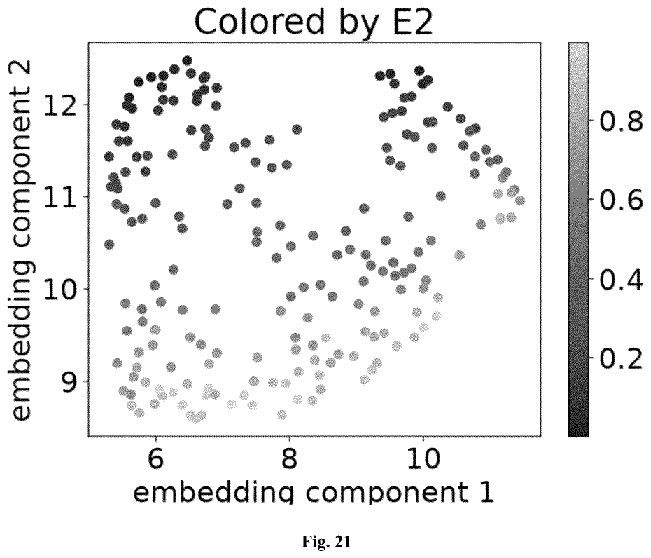

FIGS. 16 to 21 are comparable with FIGS. 10 to 15 in that they illustrate the effects of different moments on Wasserstein distances, dimensions of the embeddings and respective scores, and gradations for embedded components, respectively.

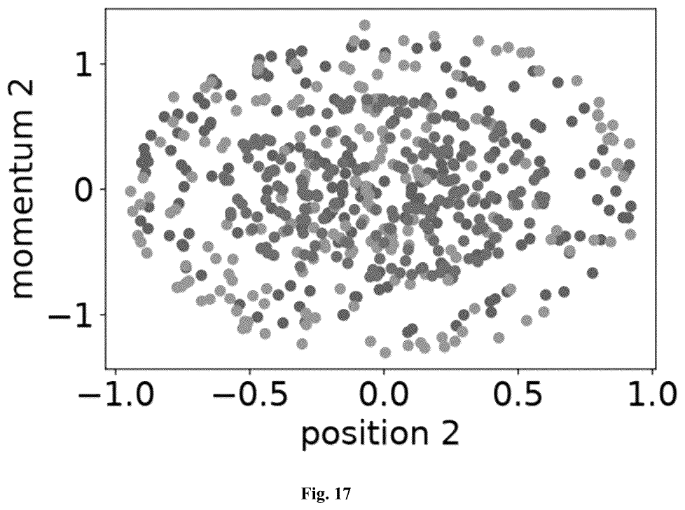

FIGS. 16 to 21 refer to the coupled oscillator shown in FIG. 9. FIGS. 16 to 21 differ from FIGS. 10 to 15 in that larger scale values are used for the moments on the X-axes of FIGS. 16 and 17. This results in different colored gradations for embedded components 1 and 2.

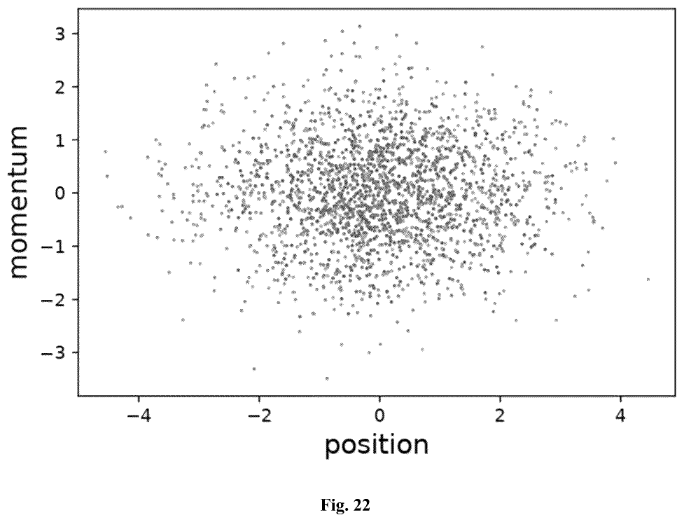

FIGS. 22 to 25 illustrate the effect of a noisy pendulum.

FIG. 22 illustrates the position values (X-axis) as a function of the momentum values (Y-axis) of the noisy pendulum.

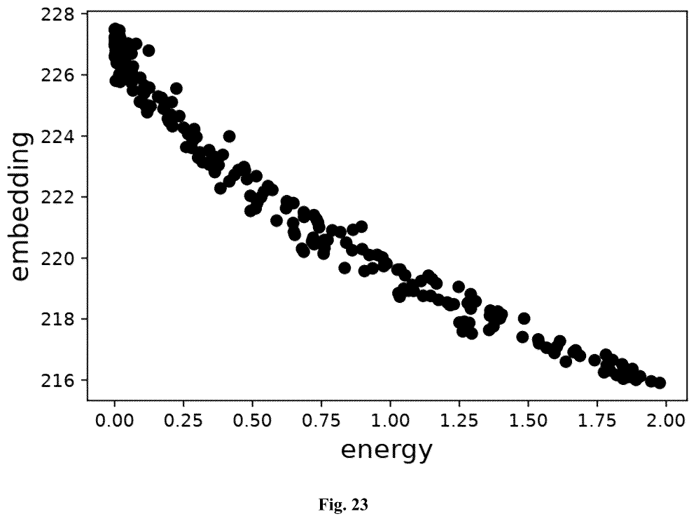

The coordinate system of FIG. 23 shows the correlation of the embedding values with the energy values.

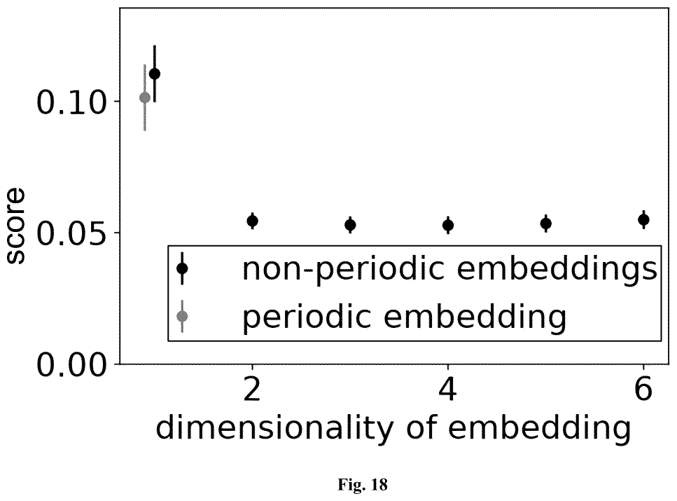

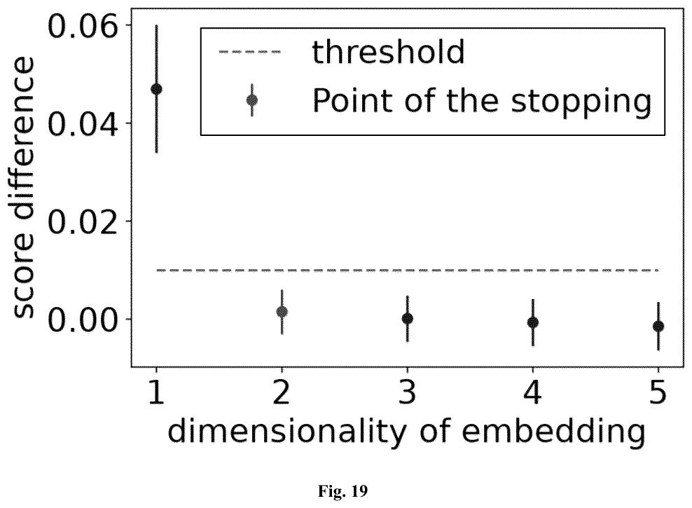

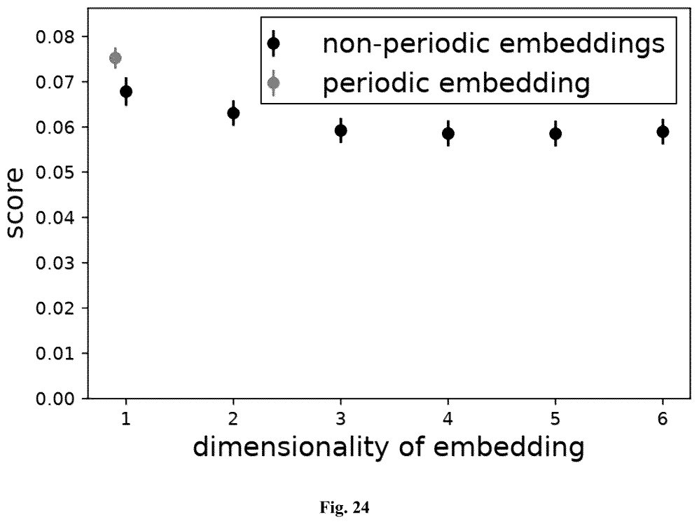

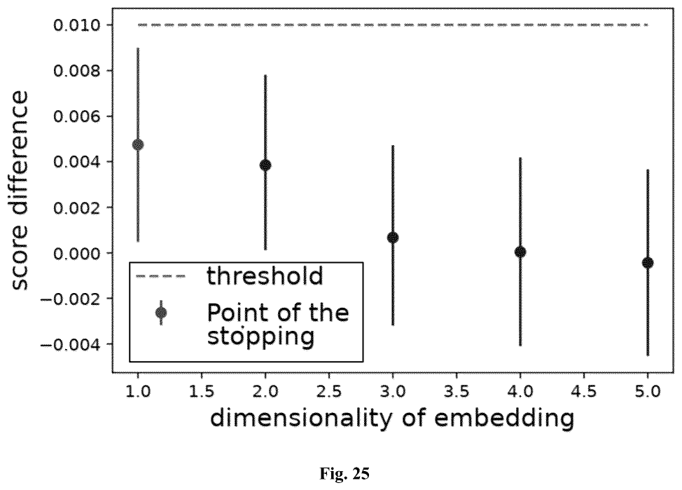

FIGS. 24 and 25 are comparable with the illustrations in FIGS. 18 and 19. FIGS. 24 and 25 show the effects of the noisy pendulum.

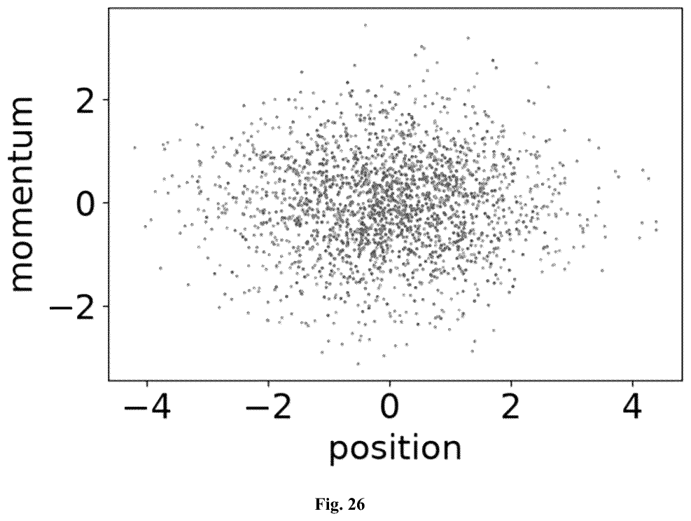

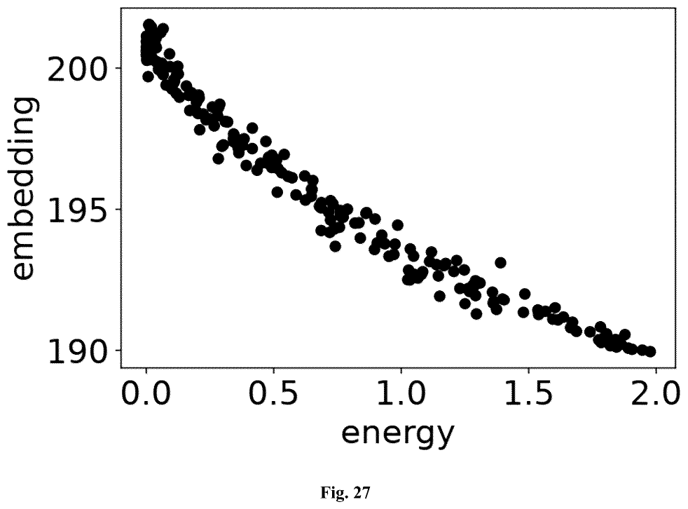

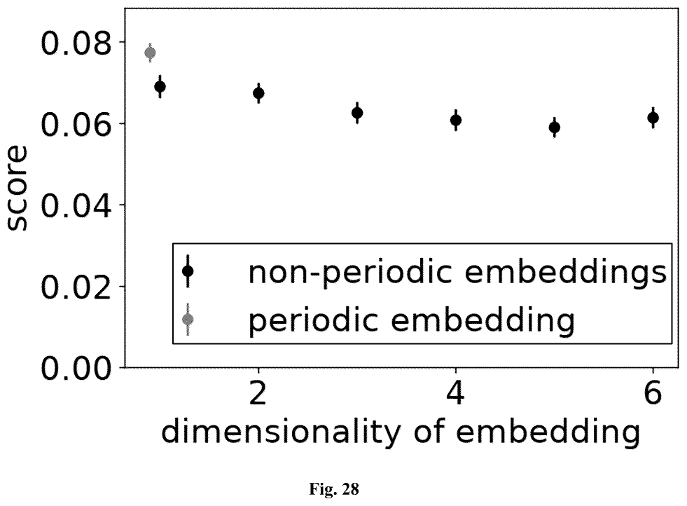

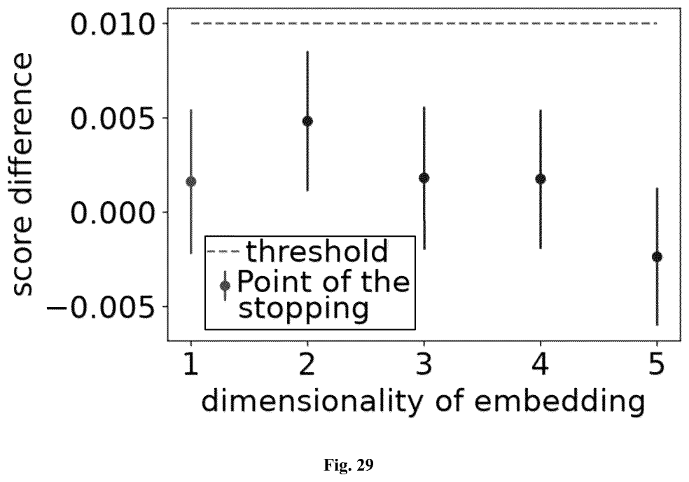

FIGS. 26 to 29 are comparable with the illustrations in FIG. 22 to FIG. 25.

FIGS. 26 to 29 differ from FIG. 22 to FIG. 25 in that a larger momentum scale is used for the moments on the X-axes of 26 to 29. This results in different values of non-periodic and periodic embeddings.

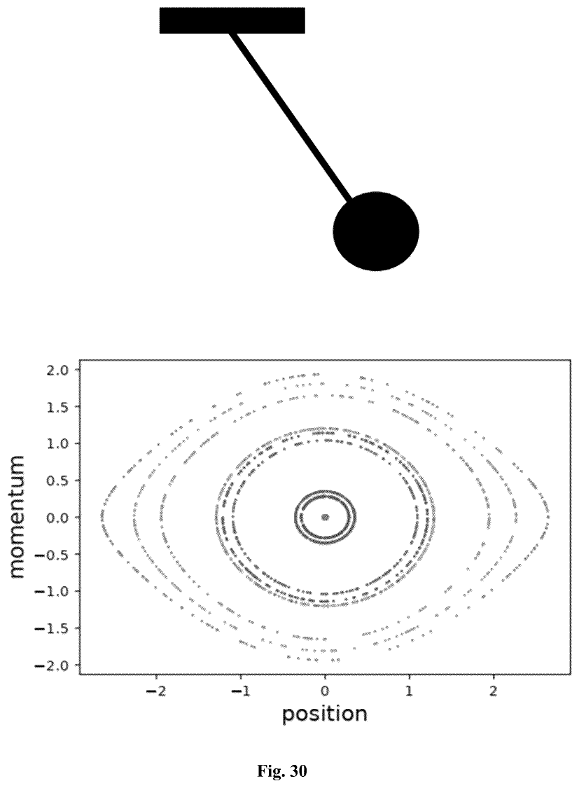

FIG. 30 is comparable with FIG. 5. At this point, references are made to the explanations for FIG. 5 for ease of discussion.

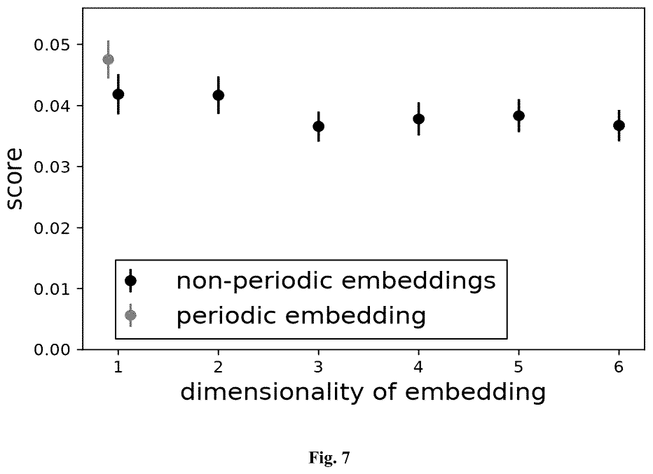

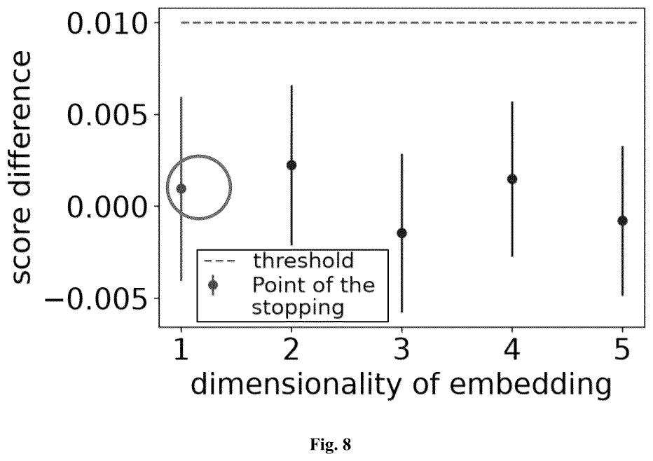

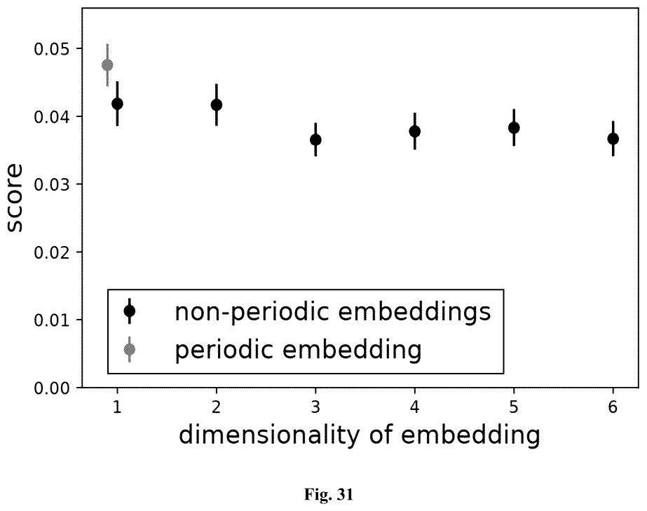

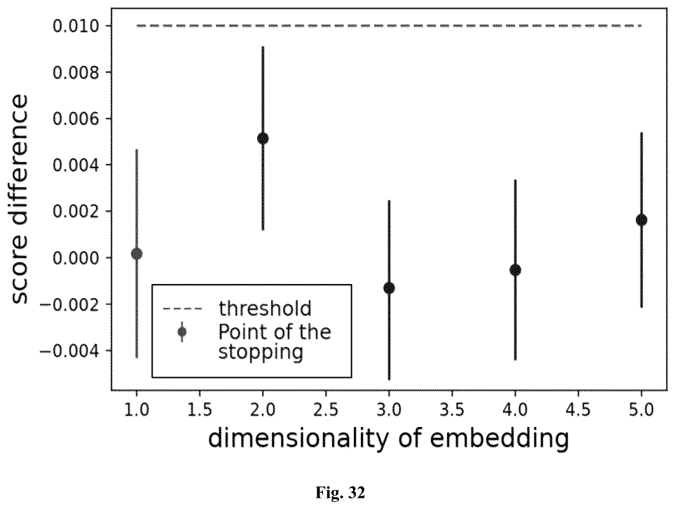

Similarly, reference is made to comparable FIGS. 7 and 8 to explain FIGS. 31 and 32.

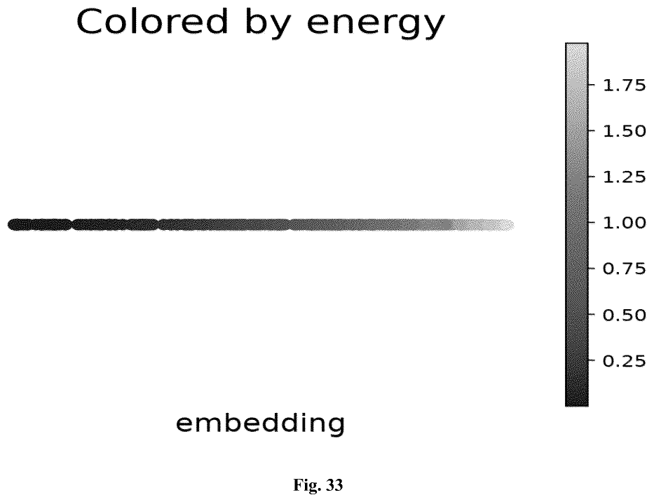

FIG. 33 shows a constant embedding colored by energy.

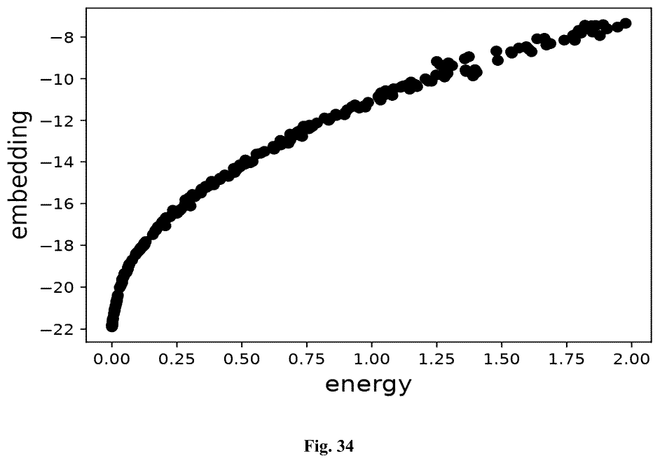

Referring to FIG. 34, a coordinate system illustrates the correlation of the embedding values with the energy values.

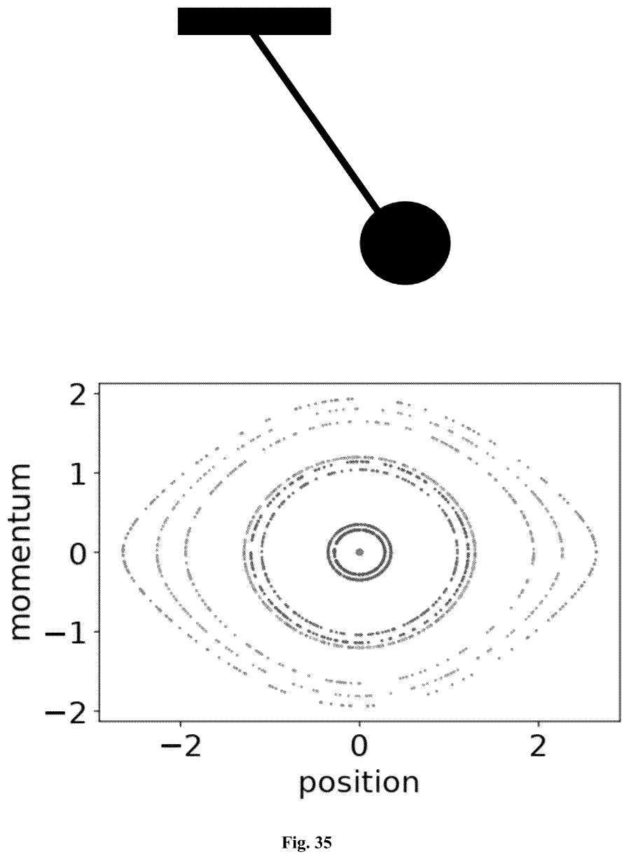

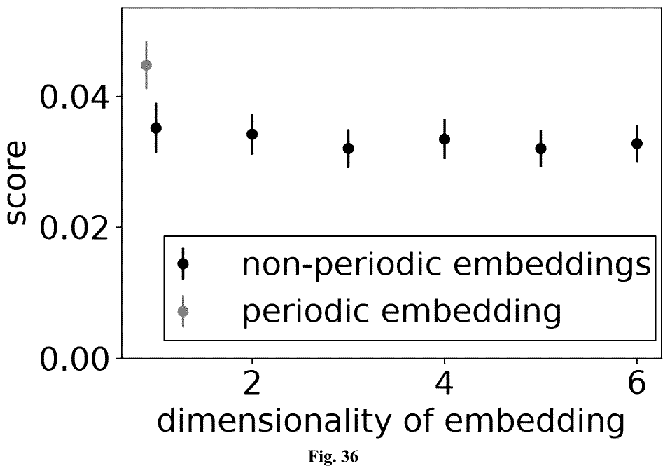

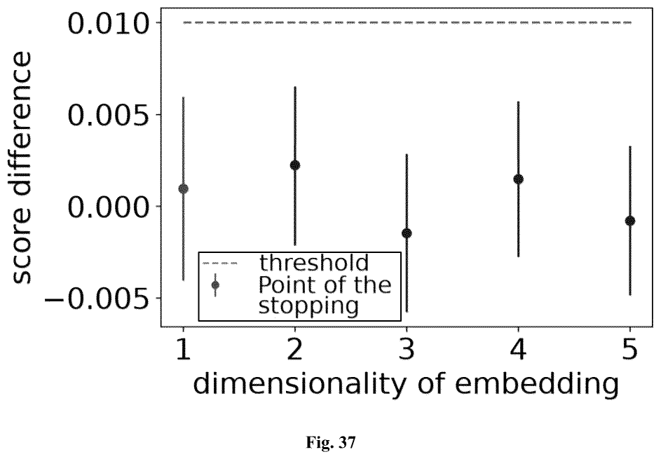

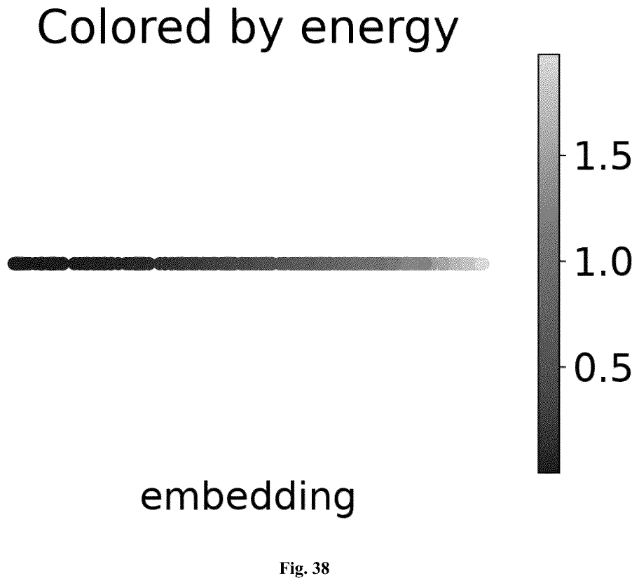

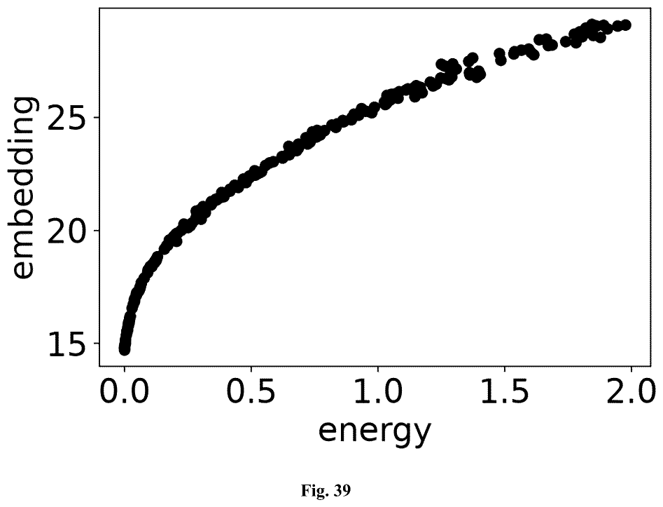

With regard to FIGS. 35 to 37, embodiments refer to the explanation of FIGS. 5, 7 and 8. With regard to FIGS. 38 to 39, embodiments refer to the explanation of FIGS. 33 and 34.

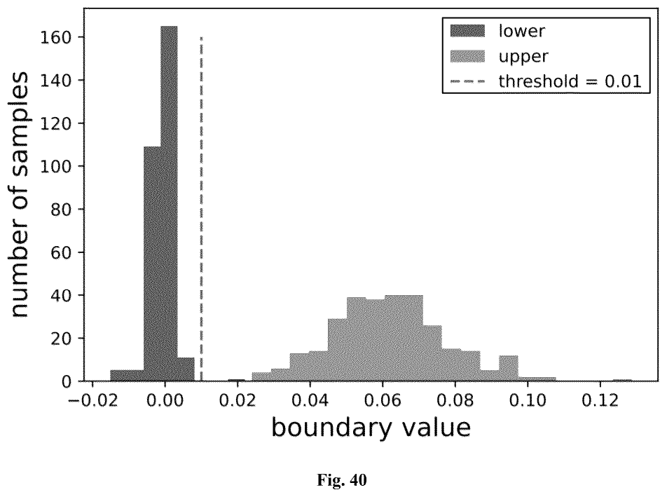

The coordinate system of FIG. 40 shows the correlation of the number of samples with the boundary values.

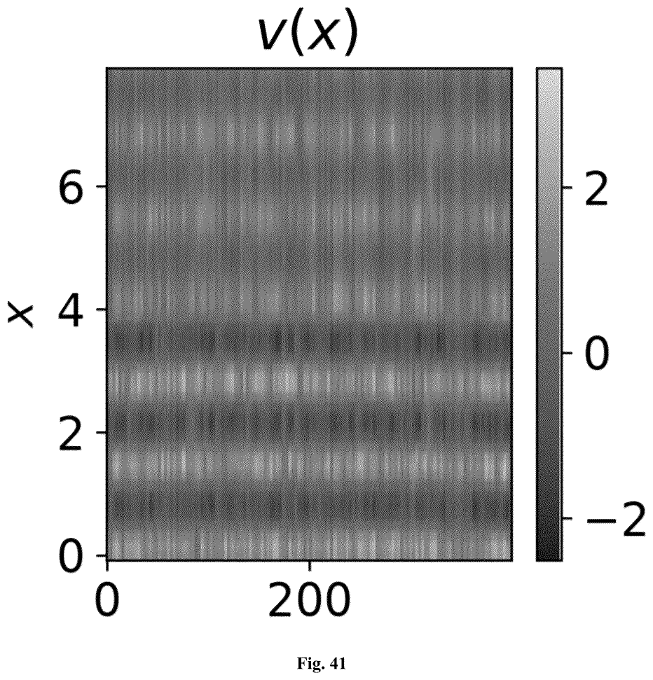

FIGS. 41 to 46 show predetermined correlations.

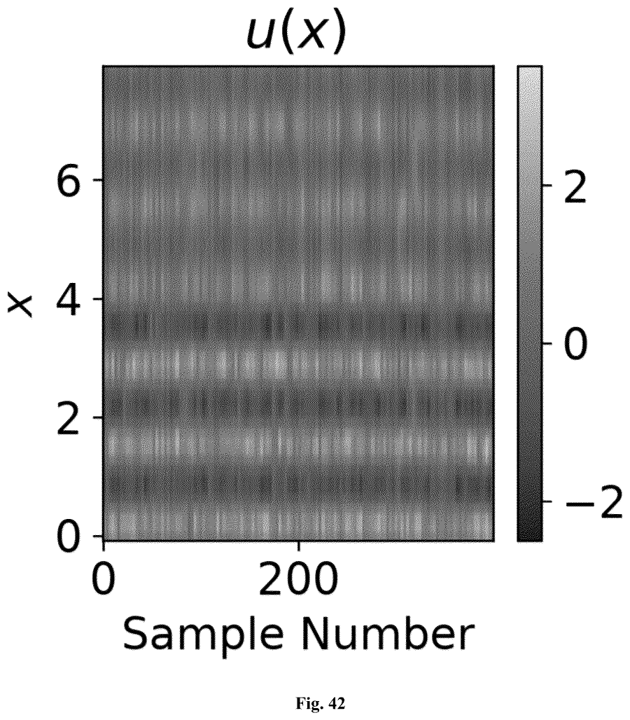

FIG. 41 and FIG. 42 illustrate the correlation between the variables v (x) and u (x) and the sample numbers respectively.

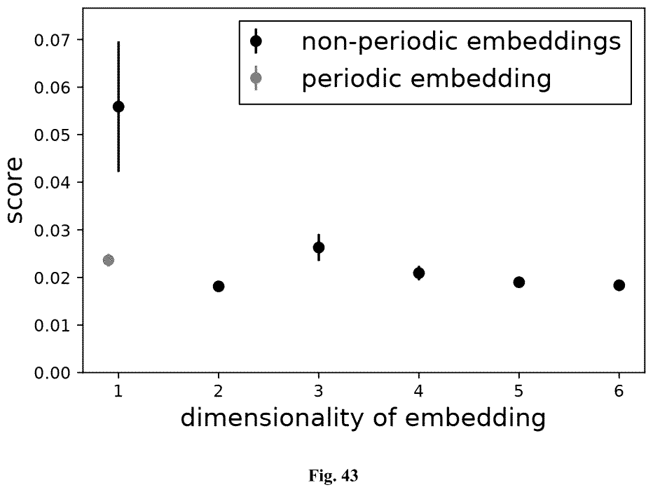

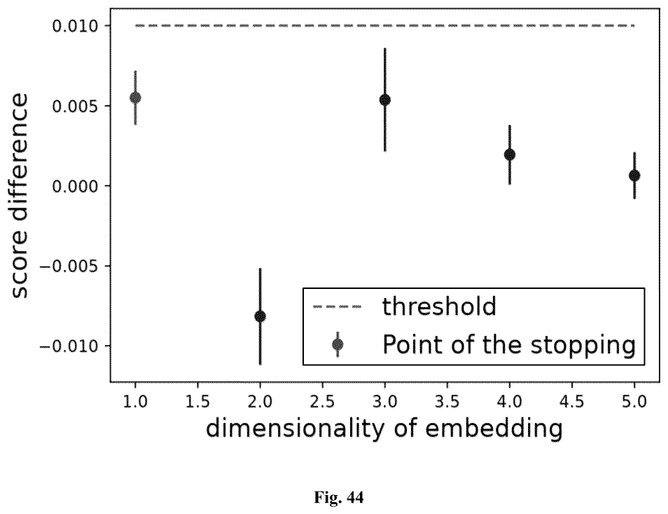

FIG. 43 and FIG. 44 illustrate the correlation between the dimensionality of embedding and the score values or the score differences, respectively.

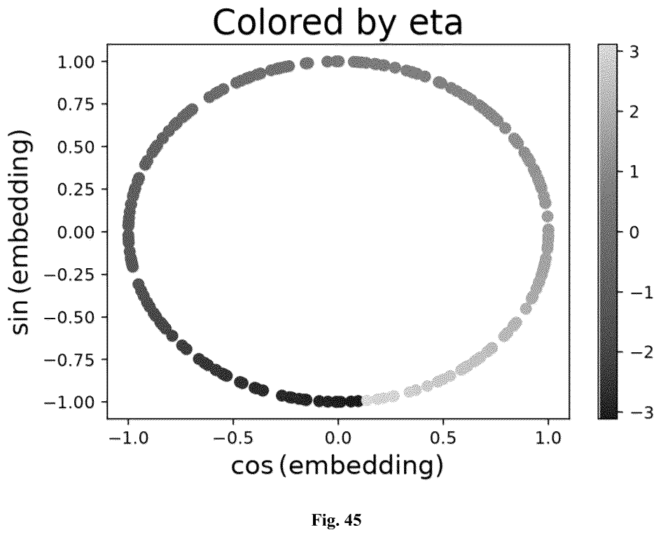

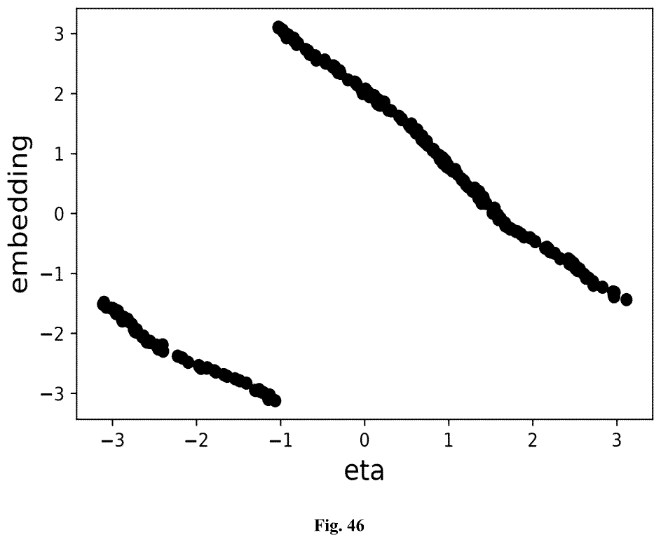

FIG. 45 and FIG. 46 illustrate the correlation between the sin (embedding) and the cos (embedding) or the embedding and eta. Alternatively, a correlation can be established between the sin (embedding) and the cos (embedding). Also, in this alternative, a correlation can be established between the embedding and eta.

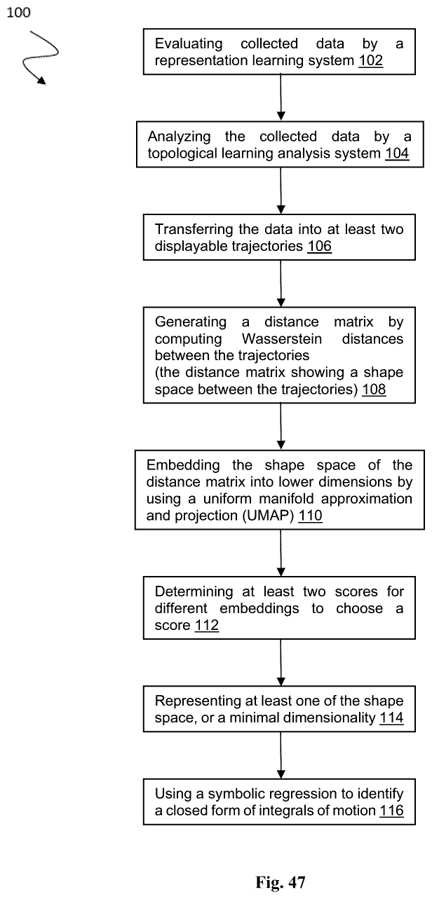

FIG. 47 is a flowchart of a method 100 for uncovering a conservation law in physical systems, according to an embodiment. At 102, method 100 comprises evaluating collected data by a representation learning system. At 104, method 100 further comprises analyzing collected data by a topological learning analysis system. At 106, method 100 further comprises transferring data into at least two displayable trajectories. At 108, method 100 further comprises generating a distance matrix including Wasserstein distances between the trajectories. At 110, method 100 further comprises embedding shape space of the distance matrix into lower dimensions. In an embodiment, shape space embedding can include using UMAP. At 112, method 100 further comprises determining at least two scores for different embeddings. At 114, method 100 further comprises representing at least one of the shape space or minimal dimensionality. At 116, method 100 further comprises using a symbolic regression to identify a closed form of integrals of motion.

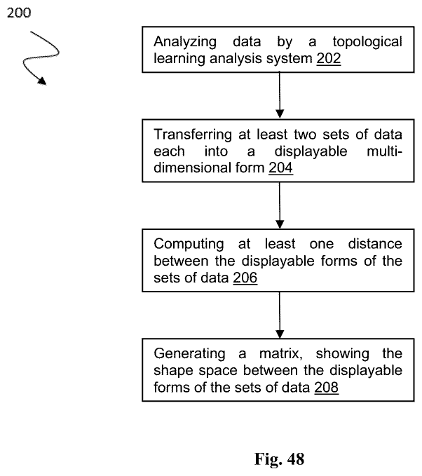

FIG. 48 is a flowchart of a method 200 for uncovering a conservation law, according to an embodiment. At 202, method 200 comprises analyzing data by a topological learning analysis system. At 204, method 200 further comprises transferring at least two sets of data into a displayable multi-dimensional form. At 206, method 200 further comprises computing at least one distance between the displayable forms of the sets of data. At 208, method 200 further comprises generating a matrix depicting the shape space between the displayable forms of the sets of data.

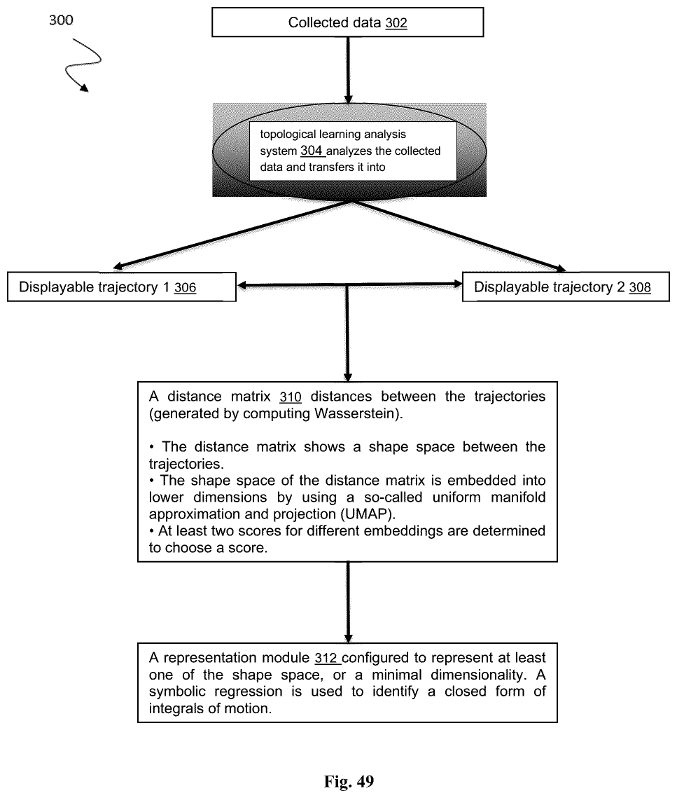

FIG. 49 is a block diagram of a system 300 for uncovering a conservation law, according to an embodiment. System 300 generally comprises collected data 302 as an input to topological learning analysis system 304. Topological learning analysis system 304 is configured to analyze the collected data 302 and transfer the collected data 302 into displayable trajectory 1 306, displayable trajectory 2 308, and distance matrix 310.

In an embodiment, distance matrix 310 includes distances between displayable trajectory 1 306 and displayable trajectory 2 308. Distance matrix 310 can be operably coupled to a representation module 312 configured to represent at least one of shape space or a minimal dimensionality. In an embodiment, representation module 312 further implements a symbolic regression to identify a closed form of integrals in motion.

1. A method for uncovering a conservation law in physical systems, the method comprising:
evaluating collected data by a representation learning system;
analyzing the collected data by a topological learning analysis system, and transferring the data into at least two displayable trajectories;
generating a distance matrix by computing Wasserstein distances between the trajectories, with the distance matrix showing a shape space between the trajectories;
embedding the shape space of the distance matrix into lower dimensions by using a uniform manifold approximation and projection (UMAP);
determining at least two scores for different embeddings to choose a score;
representing at least one of the shape space, or a minimal dimensionality; and
using a symbolic regression to identify a closed form of integrals of motion.

2. The method according to claim 1, wherein the trajectory is represented by at least two points on the trajectory, wherein each point represents at least one data, respectively.

3. The method according to claim 1, wherein the trajectory is ergodic and amplitudes of at least two variations in different conserved quantities have similar effect on the Wasserstein distance.

4. The method according to claim 1, further comprising normalizing the Wasserstein distances data, including by a zero mean and/or a unit maximal value.

5. The method according to claim 1, wherein varying an output_metric hyper-parameter of the UMAP controls a topology of a target space.

6. The method according to claim 6, wherein the topology of the target space is controlled by using a distance on a circle along an arc.

7. The method according to claim 1, wherein the topological learning system defines a target space.

8. The method according to claim 1, wherein UMAP comprises an output_metric hyper-parameter.

9. The method according to claim 7, wherein the target space is controlled by varying the output_metric hyper-parameter of the UMAP.

10. The method according to claim 1, wherein the representation of the shape space by the embedding is measured by a neighbor deviation score (NDS).

11. The method according to claim 10, wherein the NDS utilizes a reference trajectory.

12. The method according to claim 10, wherein the NDS is an average absolute deviation in rank of the at least two points on the trajectory.

13. The method according to claim 11, further comprising determining distances from all trajectories to the reference trajectory.

14. A system for uncovering a conservation law, comprising:
a representation learning system configured to evaluate collected data;
a topological learning analysis system configured to analyze the collected data and transfer the data into at least two displayable trajectories;
a distance matrix generated by computing Wasserstein distances between the trajectories, wherein the distance matrix shows a shape space between the trajectories, and wherein the shape space of the distance matrix is embedded into lower dimensions by using a so-called uniform manifold approximation and projection (UMAP), wherein at least two scores for different embeddings are determined to choose a score,
a representation module configured to represent at least one of the shape space, or a minimal dimensionality, wherein a symbolic regression is used to identify a closed form of integrals of motion.

15. The system according to claim 14, wherein the trajectory is represented by at least two points on the trajectory, wherein each point represents at least one data, respectively.

16. The system according to claim 14, wherein the trajectory is ergodic and amplitudes of at least two variations in different conserved quantities have similar effect on the Wasserstein distance.

17. The system according to claim 14, further comprising normalizing the Wasserstein distances data, including by a zero mean and/or a unit maximal value.

18. The system according to claim 14, wherein varying an output_metric hyper-parameter of the UMAP controls a topology of a target space.

19. The system according to claim 14, wherein the representation of the shape space by the embedding is measured by a neighbor deviation score (NDS).

20. A method for uncovering a conservation law, the method comprising:
analyzing data by a topological learning analysis system, and transferring at least two sets of data each into a displayable multi-dimensional form;
computing at least one distance between the displayable forms of the sets of data; and
generating a matrix, showing the shape space between the displayable forms of the sets of data.
